(19) United States
(12) Patent Application Publication
(10) Pub. No.: US 2026/0311043 A1
(43) Pub. Date: Oct. 8, 2026

(54) OPTIMIZING ARTIFICIAL INTELLIGENCE (AI) MODEL TRAINING AND INFERENCING PERFORMANCE THROUGH SERVICE CLASS PRIORITIZATION

(71) Applicant: INTERNATIONAL BUSINESS MACHINES CORPORATION, ARMONK, NY (US)

(72) Inventors: SIMON FLAIG, ROTTENBURG (DE); JAKOB CHRISTOPHER LANG, WALDDORFHÄSLACH (DE); DARKO ZIVKOVIC, GÄRTRINGEN (DE); ANASTASIIA DIDKOVSKA, BOEBLINGEN (DE)

(21) Appl. No.: 19/173,463

(22) Filed: Apr. 8, 2025

(51) Int. Cl. G06N 20/00; G06F 11/34

(52) U.S. Cl. CPC G06N 20/00; G06F 11/3433

(57) ABSTRACT

In an embodiment, optimizing AI model training and inferencing performance through service class prioritization includes detecting one or more patterns in a plurality of service classes previously executed on a computing system, wherein each service class in the plurality of service classes includes a respective set of one or more work items; determining, based on the one or more patterns, a pattern strength score for each service class in the plurality of service classes; selecting, based on the pattern strength score, a service class for inclusion in a training data set; and training a machine learning model using the training data set.

### BACKGROUND

The present disclosure relates to methods, apparatus, and products for optimizing artificial intelligence (AI) model training and inferencing performance through service class prioritization. As modern computing systems increasingly rely on AI-driven decision-making, AI inferencing must run continuously, consuming valuable system resources. Additionally, training AI models with large datasets is highly resource intensive. In some cases, the computational overhead of AI processing can exceed the actual benefits it provides. Furthermore, constraints on available time and system resources for inferencing necessitate a selective approach to data processing.

### SUMMARY

According to embodiments of the present disclosure, various methods, apparatus and products for optimizing AI model training and inferencing performance through service class prioritization are described herein. In some aspects, optimizing AI model training and inferencing performance through service class prioritization includes determining, for a service class among a plurality of service classes in a computing system, that a workload pattern exists for the service class. A pattern strength score is determined for the service class based on the workload pattern. A service class is selected for inclusion in a training dataset based on its pattern strength score. Selected service classes are then used to train a machine learning model, enhancing the model’s ability to predict and manage future service class executions. This technique improves the efficiency and accuracy of machine learning models by reducing the size of the training dataset and thus the size of the machine learning model, while retaining the training data that will have the most impact on and benefit to resource scheduling and workload management.

### BRIEF DESCRIPTION OF THE DRAWINGS

FIG. 1 sets forth a block diagram of an example computing system for optimizing AI model training and inferencing performance through service class prioritization in accordance with at least one embodiment of the present disclosure.

FIG. 2 sets forth a flow chart of an example method for optimizing AI model training and inferencing performance through service class prioritization in accordance with at least one embodiment of the present disclosure.

FIG. 3 sets forth a flow chart of another example method for optimizing AI model training and inferencing performance through service class prioritization in accordance with at least one embodiment of the present disclosure.

FIG. 4 sets forth a flow chart of another example method for optimizing AI model training and inferencing performance through service class prioritization in accordance with at least one embodiment of the present disclosure.

FIG. 5 sets forth a flow chart of another example method for optimizing AI model training and inferencing performance through service class prioritization in accordance with at least one embodiment of the present disclosure.

FIG. 6 sets forth a flow chart of another example method for optimizing AI model training and inferencing performance through service class prioritization in accordance with at least one embodiment of the present disclosure.

FIG. 7 sets forth a flow chart of another example method for optimizing AI model training and inferencing performance through service class prioritization in accordance with at least one embodiment of the present disclosure.

FIG. 8 sets forth a flow chart of another example method for optimizing AI model training and inferencing performance through service class prioritization in accordance with at least one embodiment of the present disclosure.

FIG. 9 sets forth a flow chart of another example method for optimizing AI model training and inferencing performance through service class prioritization in accordance with at least one embodiment of the present disclosure.

FIG. 10 sets forth a block diagram of an example computing environment for optimizing AI model training and inferencing performance through service class prioritization in accordance with at least one embodiment of the present disclosure.

### DETAILED DESCRIPTION

As modern computing systems increasingly rely on AI-driven decision-making, AI inferencing must run continuously, consuming valuable system resources. Additionally, training AI models with large datasets is highly resource-intensive. In some cases, the computational overhead of AI processing can exceed the actual benefits it provides. Furthermore, constraints on available time and system resources for inferencing necessitate a selective approach to data processing, such as prioritizing specific types of training data.

With the growing integration of AI into workload management, workload managers leverage AI to analyze patterns, predict resource demands, and optimize scheduling decisions dynamically. However, model inferencing must occur within a short amount of time to provide any benefit to the workload manager. A complex training dataset may generate many different submodels, which are combined into one large machine learning model. As the size of the model, the number of submodels and the data being used for inferencing affects model inferencing time, at times the machine learning model may not be able to complete the inferencing within this short time window to provide any meaningful resource optimizations. Embodiments described below provide an intelligent training data selection mechanism to optimize resource consumption both during training and at runtime. This optimization not only improves efficiency but also reduces the size of AI models (e.g., by reducing the number of submodels), enabling faster import, export, and processing, ultimately enhancing the responsiveness of workload management systems.

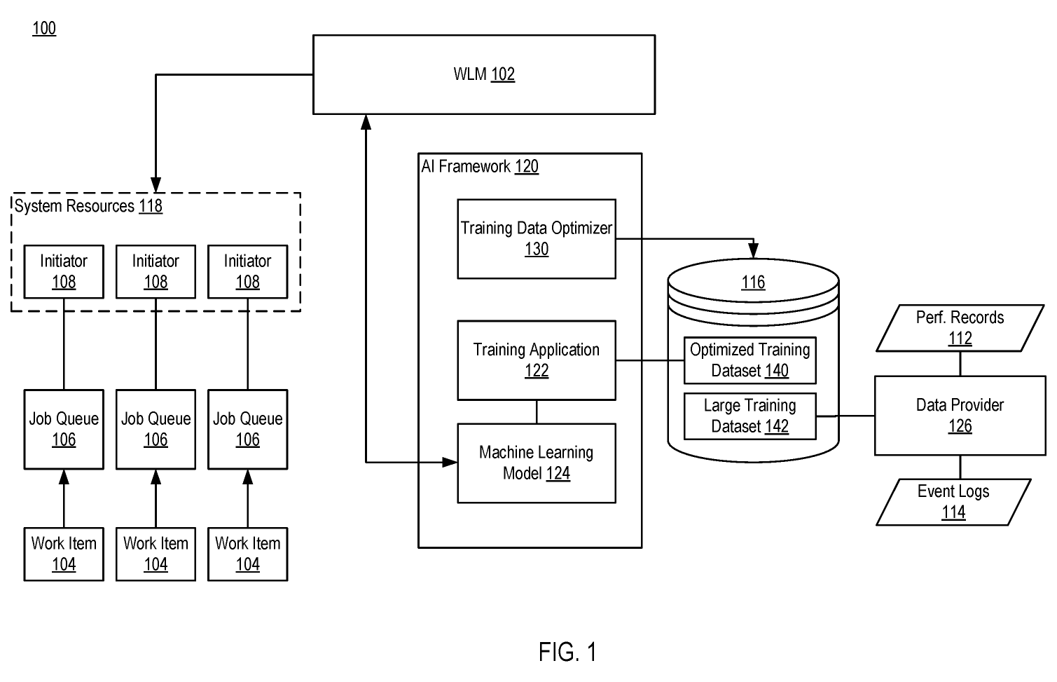

With reference now to FIG. 1, FIG. 1 sets forth a block diagram of an example computing system 100 in accordance with at least one embodiment of the present disclosure. In a particular example, computing system 100 may be based on the International Business Machines (IBM) Z Architecture, and as such may run z/OS software components or compatible components. Pertinent to the present disclosure, computing system 100 includes a workload manager (WLM) 102 embodied in a set of computer executable instructions. WLM 102 is responsible for managing a computer system's resources, ensuring they are allocated to executing tasks based on predefined performance criteria. These criteria, whether explicitly or implicitly defined, establish relative priorities among competing workloads. Performance objectives may include user-defined goals that guide resource distribution. In essence, WLM 102 dynamically adjusts system resources for incoming work units according to goal definitions that align with workload demands and user expectations to optimize computer system performance. These work units typically consist of batch jobs, transactions, and database queries. Work items 104 may be dispatched by user applications and system processes to one or more job queues 106.

In some examples, each work item is associated with a particular service class. Service classes define the importance and performance objectives of workloads in the computing environment. For example, service classes may be defined based on service level requirements or service goals. WLM 102 uses service classes to schedule and allocate resources dynamically. In some examples, each service class is designated with one or more different performance goals, such as a response time goal (e.g., interactive transactions must complete within a set time frame); an execution velocity goal (e.g., an acceptable delay for a work item, job, or workload); or a discretionary goals (e.g., workloads that run when resources are available but do not impact higher-priority tasks). WLM 102 continuously monitors and regulates system resources available to these workloads, including CPU utilization, memory usage, and disk I/O bandwidth. Within the workload management framework, work items managed by the operating system are categorized into distinct service classes. Each work item is assigned with a specific service class that determines how system resources are allocated based on pre-established prioritization goals.

WLM 102 works with resource schedulers, or job execution engines, to ensure that work items in the work queues are selected by the resource schedulers and executed on system resources 118 according to their constraints. In some computing environments, these resource schedulers are referred to herein as ‘initiators.’ In computing system 100, initiators 108 are specialized system processes that manage the execution of work items in the computing environment, and in particular the execution of batch jobs. They determine which jobs to run, allocate necessary resources, and initiate execution. WLM 102 works closely with initiators to schedule and prioritize batch workloads according to service class definitions. Thus, in some examples, initiators 108 select jobs from the job queue based on priority, allocate CPU, memory, and I/O resources for job execution, and work under the direction of WLM 102 to ensure workload distribution aligns with system objectives.

Initiators 108 for WLM-managed job classes are dynamically controlled by WLM 102, which adjusts the number of initiators 108 based on factors such as the number of jobs awaiting execution, performance goals and relative importance of work items, success rates, and the capacity of each system to do more work. At any time there may be a combination of regularly scheduled and randomly occurring workloads running. To allow batch jobs to run, WLM 102 starts and stops initiators. The number of active initiators determines the number of jobs that can run in parallel.

While batch workload management by WLM 102 is very efficient, it is primarily a reactive system. In other words, WLM 102 reacts to workloads as they arrive. However, if too many jobs are added to the job queues 106, it can take some time for WLM 102 to start new initiators. It is a challenge for WLM 102 to forecast workload patterns over extended periods, such as hours or days, which would allow it to proactively adapt to recurring usage trends. To address this, computing system 100 includes an AI framework 120 that can predict workload behavior. WLM 102 integrates the AI framework 120 into its internal processing and uses AI framework 120 to identify and predict recurring workload spikes by analyzing historical batch workload patterns. For example, batch job surges may occur at regular intervals, at specific times on weekdays, or exclusively at the end of the month. These workload variations can differ between daytime and nighttime operations, as well as across different days of the week, with each service class exhibiting unique workload trends. By leveraging AI framework 120 to anticipate these recurring workload patterns, WLM 102 can proactively initiate the necessary number of initiators for each service class before the next expected workload surge. This forward-looking approach ensures that workloads begin processing sooner, reducing queue lengths and improving overall efficiency. In effect, this proactive management helps each service class more effectively meet the performance objectives established in the WLM policy.

To that end, AI framework 120 includes a training application 122 configured to train a machine learning model 124. In some examples, the training application 122 trains the machine learning model 124 using data aggregated by a common data provider 126. For example, the common data provider 126 aggregates data from performance records 112 and system event log data 114 (e.g., system management facility (SMF) records and SYSLOG data in z/OS), as well as other related data such information technology data, in a database 116. The data aggregated by common data provider 126 is used as a training data set 142, which is typically a large training data set. Using the training data set 142, the training application 122 is designed to develop and refine machine learning models tailored to a specific system using historical data from that environment. These time series models identify recurring historical patterns related to WLM-managed batch initiators, enabling them to anticipate regular fluctuations in system workloads. Such patterns typically emerge from scheduled batch job execution and can repeat over varying timeframes, ranging from minutes to hours or even days.

By recognizing patterns in service class execution, the trained model can provide WLM 102 with advance notifications, either continuously or on-demand, before workload changes are expected. For example, if a batch initiator spike is consistently observed at 11:00 AM, the model will predict this increase shortly beforehand, allowing WLM to make proactive scheduling adjustments including starting additional initiators 108. This foresight enables WLM to initiate additional resources in advance, ensuring a smoother handling of workload surges. Despite these AI-driven predictions, the ultimate decision on initiator activation remains in WLM 102.

The effectiveness of these AI models is highly dependent on how closely the training data aligns with the system’s current workload behavior. The greatest benefits arise when service classes exhibit highly consistent workload patterns, whereas service classes with randomized workloads are unlikely to see improvements. Since workload behavior may evolve over time, machine learning model 124 may be periodically retrained using the latest system data.

Although WLM 102 can leverage AI framework 120 to improve the efficiency of the computing system by predicting the resource needs of workload executing on the computing system, training and sometimes retraining the machine learning model 124 based on workload behaviors is time consuming and resource intensive. Also, the more services classes included into the training data set that is used to train the machine learning model (e.g., all service classes in the large training data set 142), the more submodels required for the machine learning model and the longer the machine learning model requires for training and/or inferencing. Forcing the WLM 102 to wait for machine learning model 124 to make a prediction would obviate the potential efficiency gains of such predictions. Thus, an inferencing window for the machine learning model 124 to make a prediction may be constrained to a particular amount of time or a particular number of processor cycles. As such, to reduce the amount of inferencing time required by machine learning model 124, it is advantageous to reduce the size of the training dataset. That is, the training dataset can be reduced to training data that will be the most useful to machine learning model 124 in making the most impactful predictions. For example, if a service class executes once per week at a non-peak usage time, it may not be useful to train the machine learning model to learn the behavior of that service class. However, if a service class executes daily at a peak usage time, it is beneficial for machine learning model 124 to learn the behavior of that service class.

Accordingly, optimizing AI model training and inferencing performance through service class prioritization includes optimizations of the machine learning model training with an intelligent selection of training data to improve resource consumption at training time as well as runtime. This approach can also reduce the model size, which makes import and export, as well as processing time of the model more efficient. To that end, computing system 100 also includes training data optimizer 130. Training data optimizer 130 evaluates, for each service class, the impact of including that service class in the training dataset for machine learning model 124 based on whether there are observed service class patterns can facilitate proactive resource allocation . A service class is evaluated based on information about work items associated with the service class, such as when those work items were initiated, how long the work items were active, resources utilized (e.g., how many initiators were needed), and so on, as well as information about the system itself such as resource utilization levels over a period of time. Training data optimizer 130 assigns the service class a pattern strength score based on a predicted benefit of including the service class in the training dataset. Based on the pattern strength score, the service class is added to an optimized training data set 140. The optimized training data set 140 is smaller than the large training data set 142, thus allowing for faster training, smaller model size, and faster inferencing. Service classes that do not meet a pattern strength score threshold can be excluded from the optimized training data set 140.

The evaluation begins with determining whether any execution pattern exists for the service class. For example, training data optimizer 130 may determine that work items associated with the service class are initiated at a particular time of day, on particular days of the week, remain active for a particular amount of time, or any combination thereof. Service classes that exhibit no pattern will have no impact on the training of machine learning model 124; thus, these service classes can be omitted from the training dataset. Next, training data optimizer 130 evaluates the frequency of the pattern. For example, if a service class exhibits a pattern that occurs frequently, the machine learning model 124 is more likely to benefit from the inclusion of the service class in the training dataset. That is, the machine learning model 124 will be more likely to rely on the learned behavior of that service class during inferencing due to the frequency of the pattern.

In some examples, training data optimizer 130 also evaluates the resource utilization of the work items associated with the service class. Service classes that have high resource utilization will have a greater impact on model inferencing if the model is able to predict in advance that such high resource utilization is about to occur. Thus, a service class with high peak resource utilization in its pattern will be attributed a higher pattern strength score. In some examples, training data optimizer 130 also evaluates the service class’s pattern in view of the utilization pattern of system resources as a whole. That is, if the service class pattern overlaps with high resource demand from other workloads and processes, the service class will be attributed a higher pattern strength score. For example, a service class whose work items regularly execute when the CPU is 30% utilized will have less impact than a service class whose work items regularly execute when the CPU is 80% utilized. In some examples, training data optimizer 130 also evaluates how long (e.g., in time or cycles) the work items associated with the service class are active. For example, a service class that exhibits a longer active period will tie up resources for longer, and thus will be attributed a higher pattern strength score. The pattern strength score can be further scaled or weighted based on importance or priority associated with the service class.

In a particular example, training data optimizer 130 evaluates a service class to determine a peak count, which is a quantification of how frequently a pattern occurs in the execution of work items associated with the service class. Training data optimizer 130 also determines a peak height, which may be a number of work items to be executed at the same time for one service class or some other quantification of the resource consumed by the work items associated with the service class. Training data optimizer 130 also determines a peak length, which is a quantification of the amount of time that work items associated with the service class are actively executing. The pattern strength score may be determined by the product of the peak count, peak height, and peak length multiplied by a scaling coefficient tied to historical resource utilization trends in the computing system. For example, the scaling coefficient may be based on overall CPU utilization, where the pattern strength score is increased by the scaling coefficient as CPU utilization increases. In some examples, the pattern strength score is also scaled based on an importance or priority metric associated with the service class, where higher importance/priority service classes have a high pattern strength score than lesser importance/priority service classes.

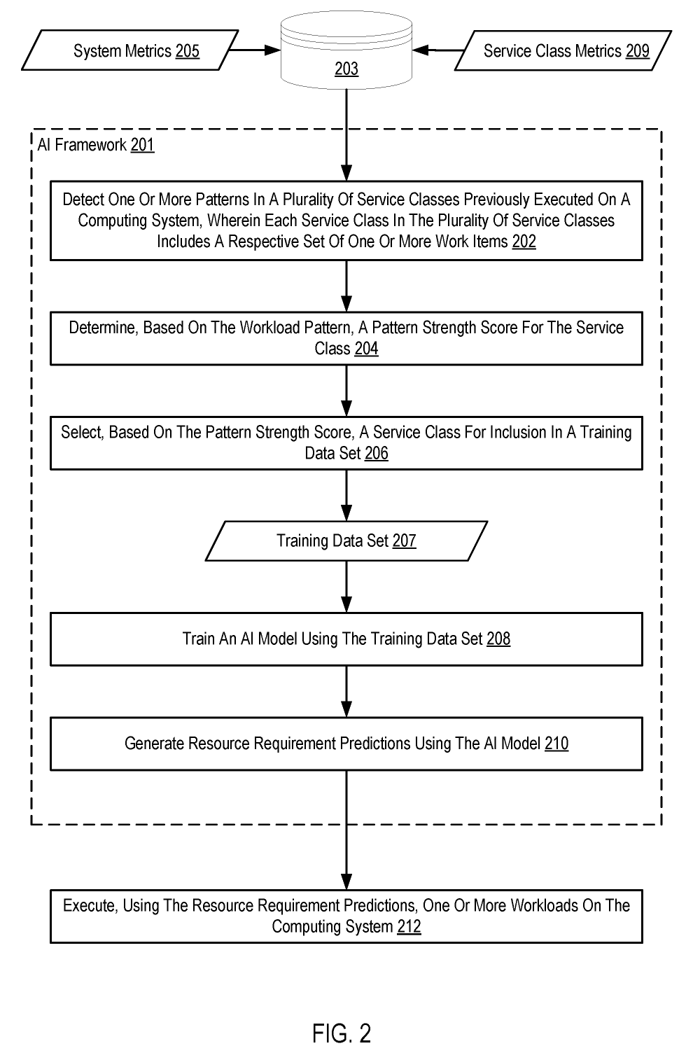

For further explanation, FIG. 2 sets forth a flow chart of an example method of optimizing AI model training and inferencing performance through service class prioritization in accordance with at least one embodiment of the present disclosure. The example of FIG. 2 includes an AI framework 201. The AI framework 201 accesses one or more databases 203 that include historical data for a computing system. For example, the one or more databases 203 include log files of system metrics 205 and records relating to workloads that are executed on the computing system, including data (e.g., timestamps) that indicate service class metrics 209 such as when jobs or work items associated with service classes are initiated and how long they execute, resources utilization associated with the service class, performance metrics, and so on. In particular, the one or more databases 203 include information relating to the activity and resource utilization of service classes and overall resource utilization in the computing system. As used herein, a service class is named group of work items that share a service constraint or service goal, in that work items in the service class should be executed to satisfy the service constrain or service goal. As used herein, ‘executing’ a service class may refer the execution of the work items that are included in that service class. The historical data for the computing system in the one or more databases 203 may also include system utilization data such as log files of system metrics (e.g., processor utilization, memory utilization, and I/O utilization metrics) and other data indicating activity in the computing system. The AI framework 201 is configured to use the data in the one or more databases 203 to preselect, from a larger dataset of service class data in the one or more databases 203, a narrower dataset of data related to service classes for training a machine learning model. In various examples, the AI framework 201 may be implemented in a workload manager, an AI framework, system data provider, and so on.

The method of FIG. 2 includes determining, for a service class among a plurality of service classes in a computing system, that a workload pattern exists for the service class, wherein the workload pattern is based on a previous execution of one or more work items included in the service class. In some examples, the AI framework 201 determines 202 that a workload pattern exists for a service class by analyzing data in the one or more databases 203 to determine which service classes exhibit a pattern of execution. For example, some workloads in a service classes may execute randomly, in which case no pattern can be discerned. Other service classes may execute accordingly to patterns that are detectable by the AI framework 201. For example, a service class may execute every day at a particular time. Within a group of service classes that exhibit a pattern, some patterns may exhibit frequent activity while others may occur less frequently. In some examples, to determine a workload pattern, the resource utilization of the service class is compared to a threshold. For example, a pattern may be determined based on a peak in resource utilization rising above this threshold. In an illustrative example, this threshold may be resource requirement such as a number of initiators required to execute work items included in the service class – for example, the service class may run in the background, requiring only one initiator, but might require five initiators once per day at the approximately the same time. If the resource requirement threshold is three initiators, then this spike in required initiators would be identified as a pattern peak. The AI framework 201 can then determine patterns in the execution of work items included in a service class based on these peaks. Although the illustrative example uses initiators as the resource requirement, it will be appreciated that the resource requirement could be expressed in terms of processor utilization, memory utilization, I/O utilization, and so on.

As used herein, a ‘service class’ refers to a named group of work items that share a particular set of service constraints such as execution goals, resource requirements, and importance. For example, a service class may be associated with a particular execution velocity or execution deadline, a CPU, memory, or I/O requirement, and/or an importance or priority level. Work items or an entire workload are assigned with a service class. For example, the service class may be user-defined and user-assigned, although some service classes may be preconfigured and/or automatically assigned. As used herein, ‘executing’ a service class refers to executing the work items, jobs, or tasks that are included in that service class.

Based on the pattern analysis of service class data and metrics, service classes that do not exhibit a pattern may be excluded from further consideration by the AI framework 201. For the service classes that do exhibit a pattern, the AI framework 201 determines a pattern strength score for each remaining service class. To that end, the method of FIG. 2 also includes determining 204, based on the workload pattern, a pattern strength score for the service class. In some examples, the AI framework 201 determines 204 the pattern strength score by analyzing, over a given period of time, multiple pattern characteristics such as pattern frequency, pattern height, and pattern duration, as well as utilization metrics of the system environment when the work items of a service class are actively executing. As will be described in more detail below, the patten frequency may be represented by a peak count, e.g., the number of pattern peaks detected during the analysis period. The pattern height may be represented by the number of work items or the actual or relative amount of resources required during the pattern peaks. The pattern duration may be represented by the amount of time or number of cycles that the pattern peak persists. One or all of these factors may be used to determine the pattern strength score. In some examples, the pattern strength score is scaled by a coefficient based on the system utilization metrics during the analysis period, which encompasses the resource drain of other workloads executing on the system. In some examples, the pattern strength score is scaled based on the importance of the service class, where the pattern strength score is increased for workloads that are considered more important.

The method of FIG. 2 also includes selecting 206, based on the pattern strength score, a service class for inclusion in a training dataset 207. In some examples, the AI framework 201 selects 206 a service class for inclusion in the training data set 207 when the pattern strength score for the service class is above a pattern strength threshold. In some implementations, the pattern strength threshold is predefined. For example, the pattern strength threshold may be set by a user. In other implementations, the pattern strength threshold may be dynamically determined based on a fixed or optimal training data set size. For example, the AI framework 201 may select the top k service classes, where the service classes are ordered by descending pattern strength scores. In an illustrative example, assume that a service class must have a pattern strength score of at least y but no more than k service classes can be included in the training data set. If there are more than k service classes with a pattern strength score of y, the AI framework 201 selects the service class with the high pattern strength score, and also selects the service class with the next-highest pattern strength score, and so on until k service classes have been selected. The selected service classes are added to the training dataset. For example, the service classes may be added to a training database in a data store.

The method of FIG. 2 also includes training 208 an AI model using the training data set 207. It will be appreciated that the training dataset 207 is reduced from a larger service class dataset that would have been used to train the AI model (e.g., machine learning model), as many service classes have been omitted from the training dataset 207 based on their pattern strength score. This increases the speed of AI model training because the training dataset 207 is smaller. This also decreases the size of the AI model, which means that the AI model consumes less storage space, consumes less bus bandwidth when loading the AI model into memory from persistent storage, and consumes less memory while the AI model is executing. Further, the AI model executes faster because it is smaller and consumes less processing resources. Still further, the AI model performs inferencing faster because of the reduced model size, thus enabling the AI model to provide resource utilization predictions more rapidly, which increases the overall efficiency of all workloads executing the computing system.

The method of FIG. 2 also includes generating 210 resource requirement predictions using the AI model. In some examples, the AI framework 201 generates resource requirement predictions by monitoring system states and utilization and applying that information as inputs to the AI model. Based on system states, including wall clock time and calendar information, the AI framework 201 predicts an amount of resources that will be required at a point in the future. For example, based on the system states applied to the AI model, the AI model may predict that a particular number of initiators should be launched to handle new work items. In other examples, the AI model may predict that CPU utilization or memory utilization will increase. In various examples, these predictions may be made seconds or minutes before the new work items arrive in the work queues. In various examples, a workload manager may request a prediction from the AI framework 201 or the AI framework 201 may issue predictions to the workload manager according to a particular cycle. In some examples, the AI framework 201 has a fixed amount of time to make its prediction in order to preserve processing resources consumed by the AI model.

The method of FIG. 2 also includes executing 212, using the resource requirement predictions, one or more workloads on the computing system. In some examples, a workload manager executes 212 one or more workloads using the resource requirement predictions by allocating resources for the workloads before they are dispatched to the workload manager. For example, the workload manager may allocate the resources for work items before the work items are inserted into the work queues.

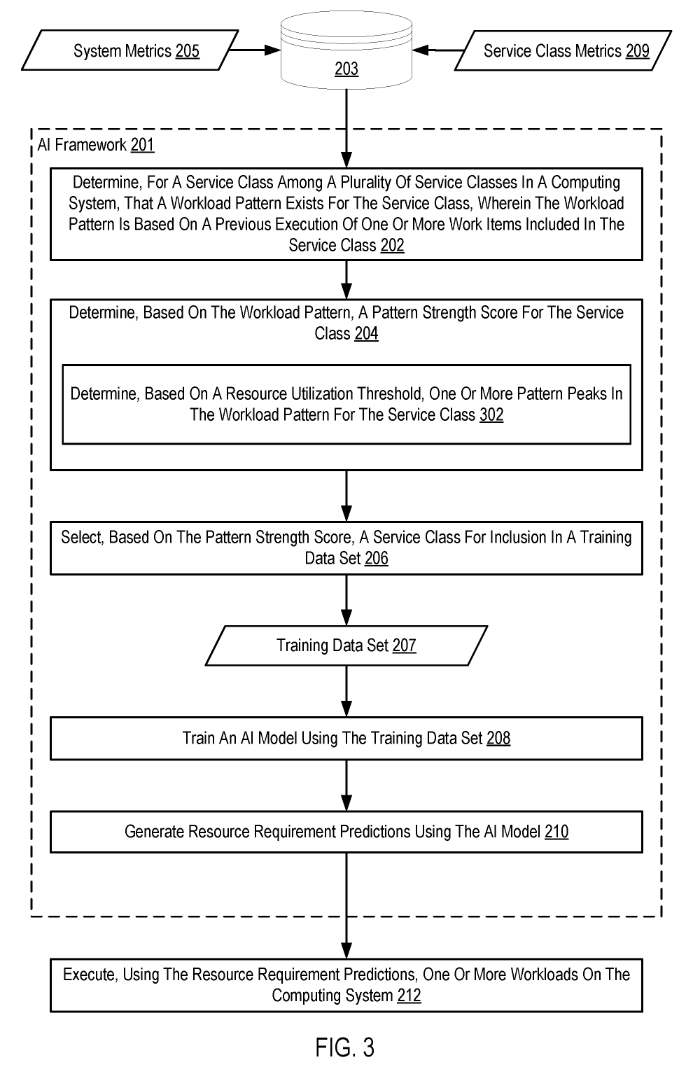

For further explanation, FIG. 3 sets forth another example method of optimizing AI model training and inferencing performance through service class prioritization in accordance with at least one embodiment of the present disclosure. The method of FIG. 3 extends the method of FIG. 2 in that determining 204, based on the workload pattern, a pattern strength score for the service class includes determining 302, based on a resource utilization threshold, one or more pattern peaks in a workload pattern. In some examples, to aid in determining whether a workload pattern for a service class exists, the AI framework 201 identifies behavior of the service class execution where the resource utilization of the service class execution is above a resource utilization threshold. As discussed above, a workload pattern includes a peak where the resource utilization of that service class during execution is above this threshold. By identifying the peaks, the AI framework 201 can identify the pattern in the service class execution, but can also identify the pattern strength (e.g., more frequent peaks reflect a stronger pattern score).

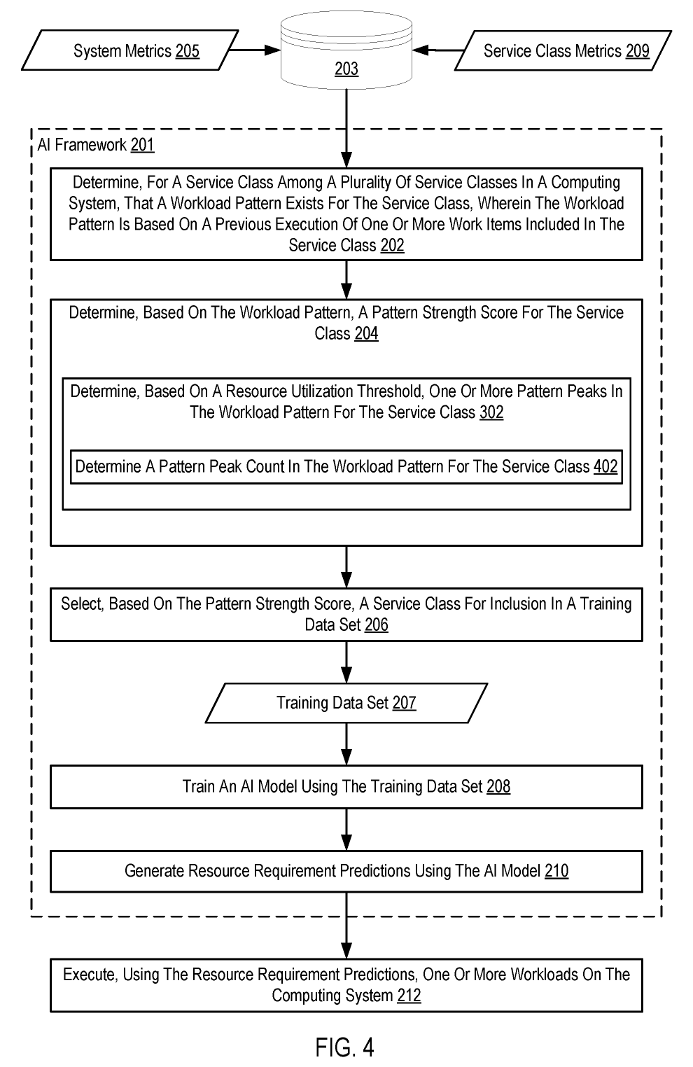

For further explanation, FIG. 4 sets forth another example method of optimizing AI model training and inferencing performance through service class prioritization in accordance with at least one embodiment of the present disclosure. The method of FIG. 4 extends the method of FIG. 3 in that determining 204, based on the workload pattern, a pattern strength score for the service class also includes determining 402 a pattern peak count in the workload pattern for the service class. As discussed above, the AI framework 201 defines a pattern peak as an escalation in resource utilization to above a resource utilization threshold. The AI framework 201 determines, for a particular analysis period, how many peaks the workload pattern includes. For example, during a given amount of time, if the service class exceeds the resource utilization threshold five times, its peak count is five. The pattern peak count is then factored into the pattern strength score as discussed above. In some examples, a weight is applied to the pattern peak count when determining the pattern strength score. For example, for some service classes the pattern peak count may be more or less important compared to other service classes.

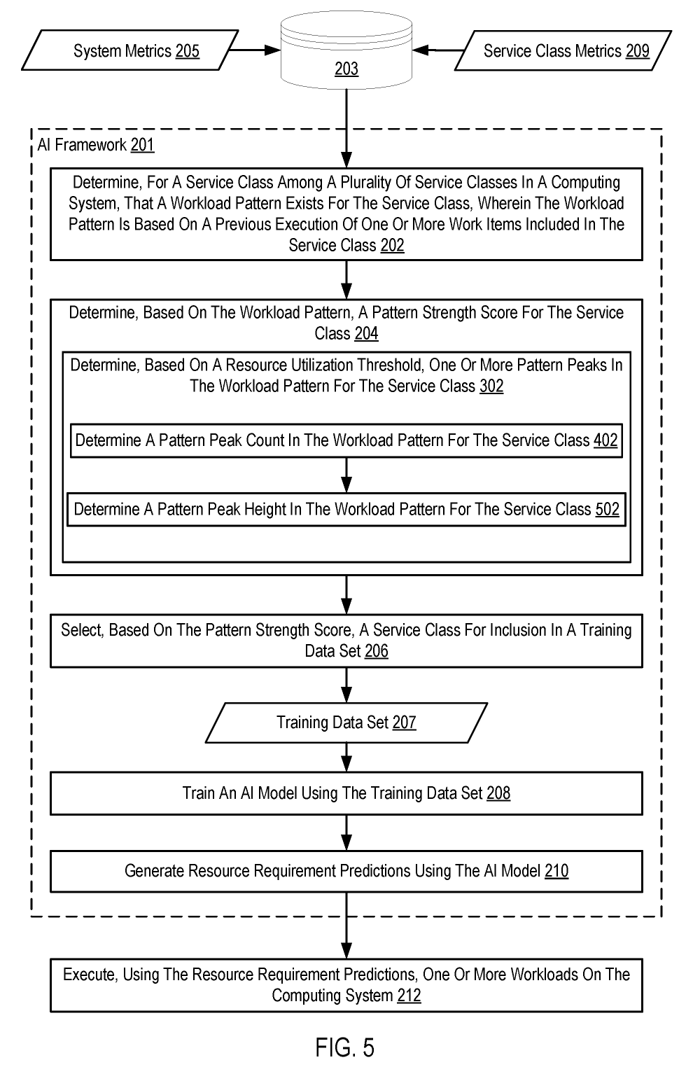

For further explanation, FIG. 5 sets forth another example method of optimizing AI model training and inferencing performance through service class prioritization in accordance with at least one embodiment of the present disclosure. The method of FIG. 5 extends the method of FIG. 4 in that determining 204, based on the workload pattern, a pattern strength score for the service class also includes determining 502 a pattern peak height in the workload pattern for the service class. In some examples, the AI framework 201 determines the peak height of one or more peaks by determining the highest amount of resources consumed by the service class execution. For example, if the service class required five initiators for execution of the service class, the pattern peak height would be five. The pattern peak height is then factored into the pattern strength score as discussed above. In some examples, a weight is applied to the pattern peak height when determining the pattern strength score. For example, for some service classes the pattern peak height may be more or less important compared to other service classes.

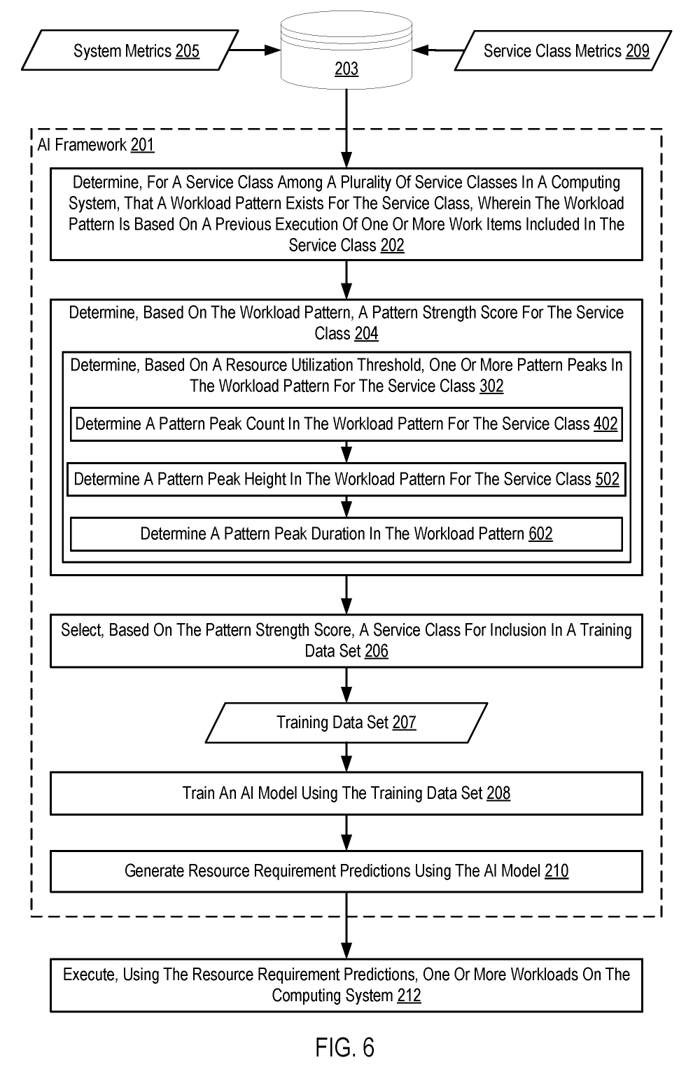

For further explanation, FIG. 6 sets forth another example method of optimizing AI model training and inferencing performance through service class prioritization in accordance with at least one embodiment of the present disclosure. The method of FIG. 6 extends the method of FIG. 5 in that determining 204, based on the workload pattern, a pattern strength score for the service class also includes determining 602 a pattern peak duration of the workload pattern associated with the service class. In some examples, the AI framework 201 determines the pattern peak duration by determining how long (in time or processor cycles) the pattern peaks last. For example, the AI framework 201 may sum the duration of each pattern peak detected within the analysis window. In other words, the pattern peak duration may be the amount of time or cycles that the service class spends above the resource utilization threshold, in that the service utilizes more resources than the resource utilization threshold that is used to identify pattern peaks. The pattern peak duration is then factored into the pattern strength score as discussed above. In some examples, a weight is applied to the pattern peak duration when determining the pattern strength score. For example, for some service classes the pattern peak duration may be more or less important compared to other service classes.

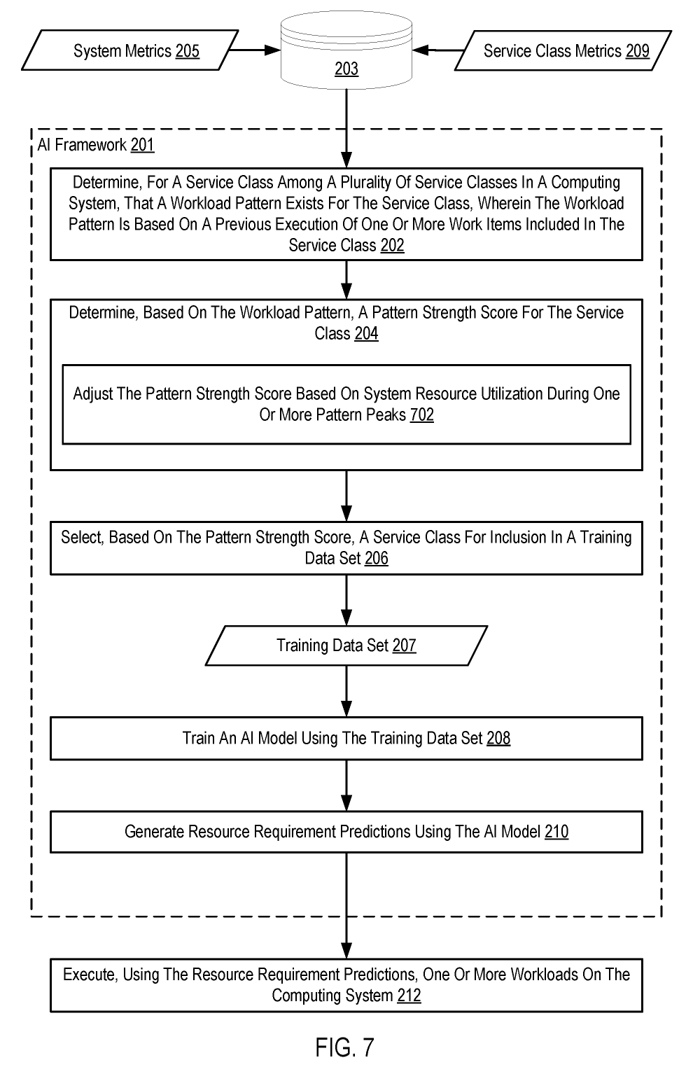

For further explanation, FIG. 7 sets forth another example method of optimizing AI model training and inferencing performance through service class prioritization in accordance with at least one embodiment of the present disclosure. The method of FIG. 7 extends the method of FIG. 2 in that determining 204, based on the workload pattern, a pattern strength score for the service class includes adjusting 702 the pattern strength score based on system resource utilization during one or more pattern peaks. In some examples, the AI framework 201 identifies, based on system log data, the overall resource utilization in the computing system during the peaks in the workload pattern for the service class. For example, if a service class peak occurs while the CPU utilization or memory utilization is high, the pattern strength score is adjusted to be higher than if the CPU utilization or memory utilization was lower. For example, the pattern strength score may be weighted upward when the overall system utilization is higher (e.g., other running processors are placing high demand on resources) to reflect that the service class is valuable to model training so that the machine learning model can learn to anticipate such spikes. However, the pattern strength score may be weighted downward when overall system utilization is lower to reflect that the service class is less valuable to model training, as the service class pattern indicates service class execution during a high availability of resources.

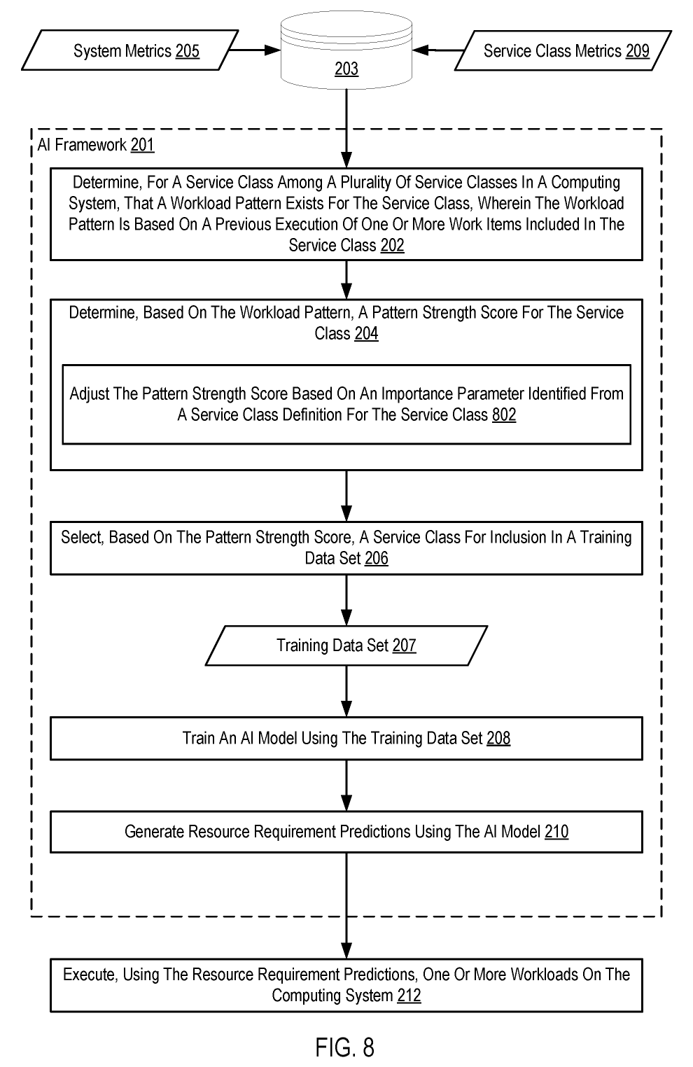

For further explanation, FIG. 8 sets forth another example method of optimizing AI model training and inferencing performance through service class prioritization in accordance with at least one embodiment of the present disclosure. The method of FIG. 8 extends the method of FIG. 2 in that determining 204, based on the workload pattern, a pattern strength score for the service class includes adjusting 802 the pattern strength score based on an importance parameter identified from a service class definition for the service class. As mentioned above, a service class definition may include an importance parameter that indicates the importance or priority for execution of the service class. Accordingly, the pattern strength score for a service class may be weighted upward in accordance with a parameter reflecting higher importance (e.g., real-time jobs) and the pattern strength score may be weighted downward in accordance with a parameter reflecting lower importance (e.g., background jobs).

Consider an illustrative example where peaks are defined based on a resource requirement metric that defines resource requirements in units (e.g., the number of initiators utilized), and the threshold for determining a peak is three units, and the duration of a peak is defined in number of cycles. This example is oversimplified for explanatory purposes. In this example, over the same period of time, service class A exhibits a pattern with four detected peaks, each requiring a five units of resources for a duration of ten cycles each. The pattern strength score is thus the pattern peak count times the pattern duration time the units of resources, which is four times five times ten equals a pattern strength score of ‘200.’ Over the same period of time, service class B exhibits a pattern with three detected peaks, each requiring a four units of resources for a duration of twenty cycles each. The pattern strength score is thus the pattern peak count times the pattern duration time the units of resources, which is three times four times twenty equals a pattern strength score of ‘240.’ Over the same period of time, service class C exhibits a pattern with three detected peaks, each requiring a three units of resources for a duration of five cycles each. The pattern strength score is thus the pattern peak count times the pattern duration time the units of resources, which is three times three times five equals a pattern strength score of ‘45.’ If the pattern strength score threshold is ‘100’ then service class A and service class B will be added to the training dataset and service class C will be dropped. However, the pattern strength scores can be scaled. For example, if service class A is active while the CPU utilization in the system is 90%, the pattern strength score of service class A can be scaled by a coefficient of ‘0.9’; whereas if service class B is active while the CPU utilization in the system is 70%, the pattern strength score of service class B can be scaled by a coefficient of ‘0.7’. The pattern strength score can also be scaled based on the importance of the service class as defined by an importance parameter in the service class definition. These examples are illustrative and should not be construed as limiting.

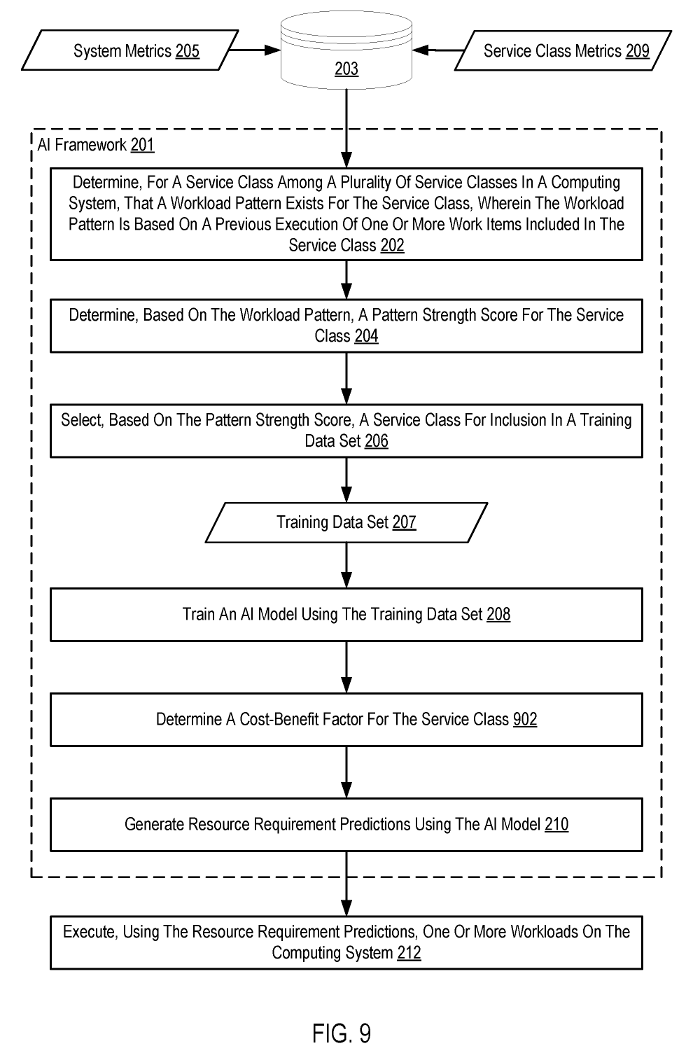

For further explanation, FIG. 9 sets forth another example method of optimizing AI model training and inferencing performance through service class prioritization in accordance with at least one embodiment of the present disclosure. The method of FIG. 9 extends the method of FIG. 2 in that the method of FIG. 9 also includes determining 902 a cost-benefit factor for the service class. In some examples, the AI framework 201 determines the cost-benefit factor for the service class by analyzing historical information for the service class. In some implementations, the AI framework 201 determines costs associated with using the machine learning model to make predictions for the service class including network utilization costs, data fetching costs, and/or data prediction costs. The benefit may be quantified based on savings in job wait time and importance level of the service class. As such, in some implementations, a formula for comparing the cost-benefit for the service class may be costs = network utilization + data fetch cost + data prediction cost; benefit = job savings * workload wait time cost / importance level. For example, the workload wait time describes the cost that occurs when the workload has to wait for some amount of time and cannot fit in a batch window. If the expected benefit is greater than the expected cost, the service class is added to the training data set.

In view of the foregoing, it will be appreciated that numerous advantages and improvements are realized by optimizing AI model training and inferencing performance through service class prioritization in accordance with the present disclosure. For training the machine learning model to make predictions about impending resource requirements, the service class training dataset is reduced from a larger service class dataset that would have been used to train the machine learning model, as many service classes have been omitted from the training dataset based on their pattern strength score. This increases the speed of machine learning model training because the training dataset is smaller. This also decreases the size of the machine learning model, which means that the machine learning model consumes less storage space, consumes less bus bandwidth when loading the machine learning model into memory from persistent storage, and consumes less memory while the machine learning model is executing. Further, the machine learning model executes faster because it is smaller and consumes less processing resources. Further, the machine learning model performs inferencing faster because of the reduced model size, thus enabling the computing system to provide resource utilization predictions more rapidly, which increases the overall efficiency of all workloads executing the computing system.

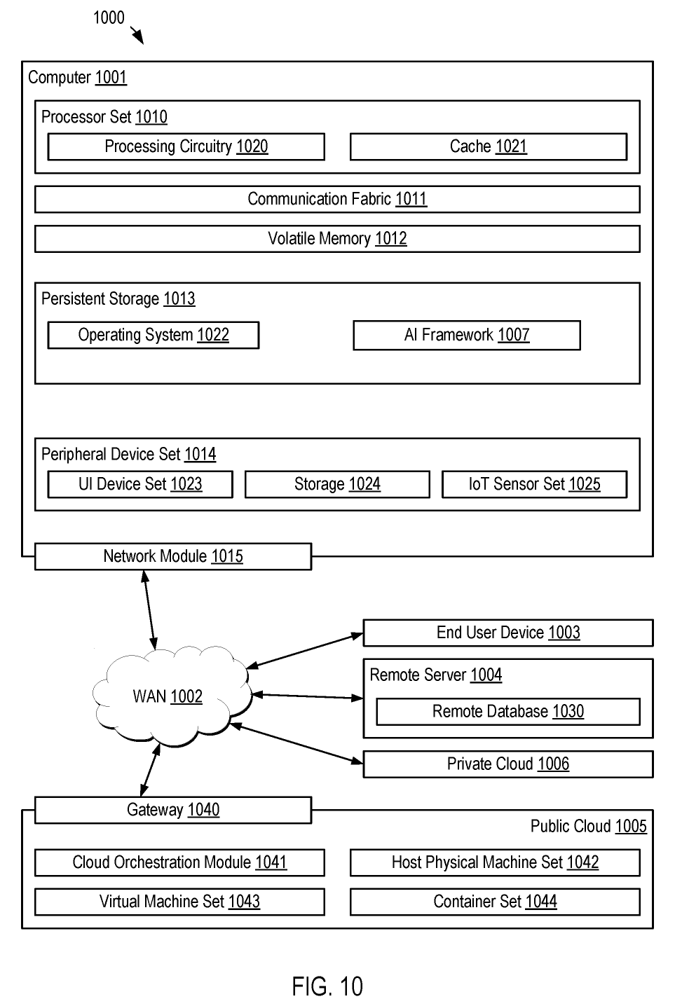

FIG. 10 sets forth an example computing environment according to aspects of the present disclosure. Computing environment 1000 contains an example of an environment for the execution of at least some of the computer code involved in performing the various methods described herein, such as AI Framework 1007. In addition to AI Framework 1007, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and AI Framework 1007, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 1021 and the other storage media discussed below. The program instructions, and associated data, are accessed by processor set 1010 to control and direct performance of the computer-implemented methods. In computing environment 1000, at least some of the instructions for performing the computer-implemented methods may be stored in AI Framework 1007 in persistent storage 1013.

Communication fabric 1011 is the signal conduction path that allows the various components of computer 1001 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in AI Framework 1007 typically includes at least some of the computer code involved in performing the computer-implemented methods described herein.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database), this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the computer-implemented methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining, for a service class among a plurality of service classes in a computing system, that a workload pattern exists for the service class, wherein the workload pattern is based on a previous execution of one or more work items included in the service class;
determining, based on the workload pattern, a pattern strength score for the service class;
selecting, based on the pattern strength score, the service class for inclusion in a training data set; and
training an AI model using the training data set.

2. The method of claim 1 further comprising:
generating resource requirement predictions using the AI model; and
executing, using the resource requirement predictions, one or more workloads on the computing system.

3. The method of claim 1, wherein the service class defines a particular performance constraint for the one or more work items included in the service class.

4. The method of claim 1, wherein determining, based on the workload pattern, a pattern strength score for the service class includes:
determining, based on a resource utilization threshold, one or more pattern peaks in the workload pattern for the service class.

5. The method of claim 4, wherein determining, based on the workload pattern, a pattern strength score for the service class includes:
determining a pattern peak count in the workload pattern for the service class, wherein the pattern peak count is factored into the pattern strength score.

6. The method of claim 5, wherein determining, based on the workload pattern, a pattern strength score for the service class includes:
determining a pattern peak height in the workload pattern for the service class, wherein the pattern peak height is factored into the pattern strength score.

7. The method of claim 6, wherein determining, based on the workload pattern, a pattern strength score for the service class includes:
determining a pattern peak duration of the workload pattern for the service class, wherein the pattern peak duration is factored into the pattern strength score.

8. The method of claim 1, wherein determining, based on the workload pattern, a pattern strength score for the service class includes:
adjusting the pattern strength score based on system resource utilization during one or more pattern peaks.

9. The method of claim 1, wherein determining, based on the workload pattern, a pattern strength score for the service class includes:
adjusting the pattern strength score based on an importance parameter identified from a service class definition for the service class.

10. The method of claim 1 further comprising:
determining a cost-benefit factor for the service class.

11. The method of claim 1, wherein the training data set excludes service classes in the plurality of service classes having a pattern strength score that is below a pattern strength score threshold and service classes for which no workload pattern is detected.

12. The method of claim 1, wherein a resource requirement prediction for executing a new work item is made in advance receiving the new work item.

13. An apparatus comprising:
a processing device; and
memory operatively coupled to the processing device, wherein the memory stores computer program instructions that, when executed, cause the processing device to:
determine, for a service class among a plurality of service classes in a computing system, that a workload pattern exists for the service class, wherein the workload pattern is based on a previous execution of one or more work items included in the service class;
determine, based on the workload pattern, a pattern strength score for the service class;
select, based on the pattern strength score, a service class for inclusion in a training data set; and
train an AI model using the training data set.

14. The apparatus of claim 13, wherein the computer program instructions, when executed, cause the processing device to:
generate resource requirement predictions using the AI model; and
execute, using the resource requirement predictions, one or more workloads on the computing system.

15. The apparatus of claim 13, wherein determining, based on the workload pattern, a pattern strength score for the service class includes:
determining, based on a resource utilization threshold, one or more pattern peaks in a service class pattern.

16. The apparatus of claim 15, wherein determining, based on the workload pattern, a pattern strength score for the service class includes one or more of:
determining a pattern peak count in the service class pattern, wherein the pattern peak count is factored into the pattern strength score;
determining a pattern peak height in the service class pattern, wherein the pattern peak height is factored into the pattern strength score; and
determining a pattern peak duration of the service class pattern, wherein the pattern peak duration is factored into the pattern strength score.

17. The apparatus of claim 13, wherein determining, based on the workload pattern, a pattern strength score for the service class includes:
adjusting the pattern strength score based on system resource utilization during one or more pattern peaks.

18. A computer program product comprising:
a set of one or more computer readable storage media; and
computer program instructions, collectively stored in the set of one or more storage media, that when executed, cause a processor set to perform computer operations comprising:
determine, for a service class among a plurality of service classes in a computing system, that a workload pattern exists for the service class, wherein the workload pattern is based on a previous execution of one or more work items included in the service class;
determining, based on the workload pattern, a pattern strength score for the service class;
selecting, based on the pattern strength score, a service class for inclusion in a training data set; and
training an AI model using the training data set.

19. The computer program product of claim 18, wherein determining, based on the workload pattern, a pattern strength score for the service class includes:
determining, based on a resource utilization threshold, one or more pattern peaks in a service class pattern.

20. The computer program product of claim 19, wherein determining, based on the workload pattern, a pattern strength score for the service class includes one or more of:
determining a pattern peak count in the service class pattern, wherein the pattern peak count is factored into the pattern strength score;
determining a pattern peak height in the service class pattern, wherein the pattern peak height is factored into the pattern strength score; and
determining a pattern peak duration of the service class pattern, wherein the pattern peak duration is factored into the pattern strength score.
